(19) United States
(12) Patent Application Publication
(10) Pub. No.: US 2026/0266340 A1
(43) Pub. Date: Sep. 10, 2026

(54) TRIPOD JOINT AND INNER JOINT PART OF A TRIPOD JOINT

(71) Applicant: GKN Driveline International GmbH, Lohmar (DE)

(72) Inventors: Thomas Weckerling, St. Augustin (DE); Orkan Eryilmaz, Lohmar (DE); Julian Lehnert, Bonn (DE)

(21) Appl. No.: 18/872,036

(22) PCT Filed: Jul. 20, 2022
(86) PCT No.: PCT/EP2022/070318

§ 371 Date: Dec. 5, 2024

(51) Int. Cl. F16D 3/205; F16D 3/202

(52) U.S. Cl. CPC F16D 3/2055; F16D 2003/2026

(57) ABSTRACT

A tripod joint has an outer joint part, an inner joint part and a plurality of roller bodies and the outer joint part has a receptacle for the inner joint part extending along a first axis of rotation and three raceways extending along the first axis of rotation and distributed in a circumferential direction. The joint inner part has a central body extending along a second axis of rotation and three journals extending from the central body along a radial direction, each having a journal axis and being distributed in the circumferential direction. One of the roller bodies is arranged on each journal, which contacts the journal with an inner circumferential surface and the respective raceway with an outer circumferential surface.

### TECHNICAL FIELD

The disclosure relates to a tripod joint and an inner joint part of a tripod joint, in particular an inner joint part of the tripod joint described.

### BACKGROUND

A tripod joint regularly comprises at least one outer joint part with a first axis of rotation and an inner joint part with a second axis of rotation. The inner joint part comprises a central body with three integrally formed journals. A roller body is arranged on each of the journals. In particular, the inner joint part can be moved along the first axis of rotation relative to the outer joint part. Furthermore, the inner joint part can be deflected relative to the outer joint part, i.e. the first axis of rotation and the second axis of rotation can be arranged at a so-called deflection angle relative to each other.

Joints of this type are known, for example, from WO 2009/052857 A1. The outer joint part comprises a longitudinal axis (first axis of rotation) and a cavity (receptacle) running along the longitudinal axis with at least one open end, with three recesses (raceway) running parallel to the longitudinal axis being formed in the outer joint part. The inner joint part comprises a (separate) longitudinal axis (second axis of rotation) and a central body on which three journals are formed, each with a journal axis extending radially from the longitudinal axis. A roller body is arranged on each journal. Each roller body is accommodated for longitudinal movement in a recess in the outer joint part. The roller body can be arranged on the journal via bearing bodies (rolling elements) or via an additional inner ring. In particular, the roller body comprises at least one outer ring and the bearing bodies, possibly also an inner ring, whereby the bearing bodies are then arranged between the outer ring and the inner ring.

Tripod joints have been manufactured and sold by the applicant for a long time, for example under the name AAR tripod joints. They are used in particular for side shafts of motor vehicles, which serve as the drive connection between a differential gear and the drive wheels. So-called constant velocity ball joints are usually used on the wheel side and the AAR tripod joints listed here are used as sliding joints next to the differential gear. The AAR tripod joints are designed in particular for deflection angles of the order of 23 degrees to 26 degrees (or less).

The journal contacts the bearing bodies or the inner ring of the roller body via so-called sliding surfaces (contact surfaces), which are designed in particular in the form of spherical segments. These sliding surfaces are aligned in a circumferential direction so that a torque acting around the longitudinal axes of the joint is transmitted via the sliding surfaces of the journal to the roller body and from the roller body to the recesses (or vice versa).

In pull/traction operation of a motor vehicle, i.e. when the motor vehicle is driven by a drive unit, the journal contacts the roller body with one of the sliding surfaces and the roller body contacts only one side of the recesses. In push mode or when the vehicle is in sail mode, i.e. when drive torques are applied starting from the wheel and the drive unit is still connected (push mode) or disconnected (sail mode), the journal contacts the roller body with the other of the sliding surfaces and the roller body contacts only the other side of the recesses. In the push mode or the sail mode, the direction of the torques introduced and the direction of rotation of the joint are opposite to each other; in the pull mode, they are in the same direction.

To achieve particularly advantageous guiding properties, an offset is provided between the first pitch radii of the sliding surfaces of the journals and the second pitch radii of the recesses.

The pitch radius of the journals is the so-called effective radius. This is defined for an extended (not deflected) joint, i.e. the longitudinal axes or axes of rotation are arranged coaxially to each other. The effective radius defines the lever arm of the resultant force when transmitting a torque. The pitch radius of the journals is therefore the radius, starting from the longitudinal axis of the inner joint part, on which, for example, the centers of the spherical segment-shaped sliding surfaces of the journal are arranged when the joint is extended.

The pitch radius of the outer joint part or of the recesses is also the so-called effective radius, which is defined for an extended joint, i.e. the longitudinal axes or axes of rotation are arranged coaxially to each other. The effective radius defines the lever arm of the resultant force when transmitting a torque.

The definition of the pitch circle radius (also known as the pitch circle radius PCR) is generally known, especially for tripod joints.

The offset of the pitch circle radii is therefore the difference between these pitch circle radii.

The properties of a tripod joint are also defined in particular by a so-called ACFG value (Axial Cyclic Force Generation, unwanted axial forces generated by the joint). This value is specified as the root mean square value of the force, with the unit Newton root mean square [Nrms]. The value varies depending on the deflection angle of the joint, whereby the course of the value can be defined or determined for each joint depending on the deflection angle. The range of use of the joint is thus limited by a maximum deflection angle at which the ACFG value does not exceed an amount that is still considered permissible.

The object of at least some implementations of the present disclosure is to solve at least in part the problems cited with reference to the prior art. In particular, a tripod joint or an inner joint part of a tripod joint is to be proposed which has a particularly advantageous behavior with regard to the ACFG value.

### SUMMARY

A tripod joint and a joint inner part contribute to solving these tasks. Advantageous further developments are the subject of the dependent claims. The features listed individually in the claims can be combined with each other in a technologically meaningful way and can be supplemented by explanatory facts from the description and/or details from the figures, whereby further embodiments are shown.

A tripod joint (hereinafter also referred to as joint) is proposed, comprising at least an outer joint part and an inner joint part as well as a plurality of roller bodies. The tripod joint may be a sliding joint in which the inner joint part is displaceable along the first axis of rotation relative to the outer joint part.

The outer joint part has a receptacle for the inner joint part extending along a first axis of rotation and three raceways extending along the first axis of rotation and arranged (evenly) distributed in a circumferential direction.

The inner joint part has a central body extending along a second axis of rotation and three journals extending from the central body along a radial direction, each having a journal axis and arranged (evenly) distributed in the circumferential direction.

A roller body is arranged on each journal, which contacts the journal with an inner circumferential surface and the respective raceway with an outer circumferential surface. Each journal has contact surfaces for contacting the inner circumferential surface, wherein a first contact surface is oriented at least towards a first circumferential direction and a second contact surface is oriented at least towards a second circumferential direction opposite to the first circumferential direction. If the axes of rotation are arranged coaxially to one another, the first contact surfaces have a first pitch circle radius, the second contact surfaces have a second pitch circle radius and the raceways have a third pitch circle radius, with at least the first pitch circle radius and the second pitch circle radius having different values from one another.

The outer circumferential surface of the roller body may be rotated relative to the inner circumferential surface of the roller body. The inner circumferential surface can be formed, for example, by an inner ring or by rolling elements that contact the journal or the contact surfaces. If the inner circumferential surface is formed by an inner ring, rolling elements are arranged between the inner ring and the outer circumferential surface so that relative rotation is possible.

The rotation of the inner circumferential surface relative to the outer circumferential surface allows the roller body to roll along the raceways so that the inner joint part can be moved along the first axis of rotation relative to the outer joint part.

When the inner joint part is deflected, the roller bodies are guided further through the raceways, whereby at least the journals are tilted relative to the roller bodies.

The roller bodies may be guided through the raceways in such a way that it is not possible for the roller bodies to tilt relative to the raceways.

Alternatively, the roller bodies are also tilted relative to the raceways when the inner joint part is deflected.

Apart from the relative rotation, the inner circumferential surface and the outer circumferential surface may not perform any further relative movement to each other.

As defined above, the pitch circle radius of the journals may be the so-called effective radius. This is defined for an extended joint, i.e. the axes of rotation are arranged coaxially to each other. The effective radius defines the lever arm of the resultant force when transmitting a torque. The pitch radius of the journal is therefore the radius, starting from the second axis of rotation, on which, for example, the centers of the spherical segment-shaped sliding surfaces of the journal are arranged when the joint is extended.

As defined above, the pitch radius of the outer joint part or the raceways is the so-called effective radius, which is defined for an extended joint, i.e. the longitudinal axes or axes of rotation are arranged coaxially to each other. The effective radius defines the lever arm of the resultant force when transmitting a torque.

The pitch circle radius may be defined for spherical surfaces (of the journal or the outer joint part). If there is a deviation from a spherical shape (e.g. if the surface in question or its contour is formed by an ellipse or has a spline contour or torus contour), the actual contact point of the resultant forces on the surface can also be used.

The offset provided in known joints is between the first pitch radii of the sliding surfaces of the journals and the second pitch radii of the recesses. It has been found that the ACFG value or its course differs depending on the deflection angle if the joint is used in a push/sail operation or a pull operation. However, the offset can only be set to the best possible compromise for these joints, so that an ACFG value is available that is equally suitable for push/sail and pull operation.

The proposed tripod joint with the different pitch circle radii on the contact surfaces now makes it possible to adapt to push operation or sail operation on the one hand and to adapt to traction/pull operation on the other. The contact surfaces oriented in different circumferential directions therefore have different properties, i.e. different pitch circle radii. Accordingly, by adapting one (e.g. the first) pitch circle radius, an ACFG value of the joint can be designed specifically for push or sail operation and by adapting the other (i.e. the second) pitch circle radius, an ACFG value can be designed specifically for pull operation.

The first pitch circle radius and the second pitch circle radius may differ by a factor of at least 1.001, which may be by a factor of at least 1.005, or by a factor of at least 1.01.

In particular, the first pitch circle radius may be smaller or larger than the third pitch circle radius.

In particular, the second pitch circle radius may be smaller or larger than the third pitch circle radius.

In particular, the third pitch circle radius may be larger or smaller than the first pitch circle radius and the second pitch circle radius.

In particular, all ratios between the pitch circle radii may be possible, whereby the first pitch circle radius and the second pitch circle radius are always different from each other or have different values.

In particular, the contact surfaces may be spherical. However, contours of the contact surfaces that deviate from the spherical shape are also possible. For example, the respective contact surfaces can be formed by several radii of curvature that differ from one another. The radius starting points can, but do not have to, be arranged on the respective journal axis. The contact surfaces can also be elliptical or toroidal.

In particular, the inner circumferential surface may contact the surface of the respective contact surfaces at only one point in a cross-section that runs transverse to the second axis of rotation.

In particular, the raceways may be curved in a cross-section that runs transverse to the first axis of rotation. In particular, the course of the raceway in this cross-section may be formed by one or more radii. In particular, the curvature may be concave relative to the outer circumferential surface of the roller body. In particular, the course of the curvature may be in the form of a pointed arch, also known as a Gothic arch. In particular, the outer circumferential surface may contact the surface of the raceways in the cross-section at only one point or at two points or along a line.

The contact between the respective surfaces described above is described only in idealized form. If, for example, a convexly curved surface makes contact with a cylindrical surface, there is only contact at one point from an idealized point of view, although there may in fact be linear contact due to the elastic deformation of the respective surface.

In particular, each roller body comprises an inner ring with an inner circumferential surface, an outer ring with an outer circumferential surface and a plurality of rolling elements between the inner ring and the outer ring.

In particular, the outer circumferential surface may have a convex shape relative to the raceways.

In particular, the inner circumferential surface may be cylindrical.

In particular, the inner circumferential surface may be concave in relation to the contact surfaces. In this context, concave means that the inner circumferential surface has a central area that is set back relative to the contact surfaces and, adjacent to the central area, an outer area that projects towards the contact surfaces.

The central area can be cylindrical or concave. In particular, the concave curvature in the central area may extend into the outer areas with a constant or changing radius. The outer areas can have a conical shape starting from the central area (curved or cylindrical).

The concave design of the inner circumferential surface allows the roller body or the inner ring to be fixed on the journal during operation of the tripod joint. In particular, this means that the inner ring may not need to be fixed in relation to the outer ring.

Usually, for example, such a fixation is provided so that the inner ring can only rotate relative to the outer ring. However, this fixation, usually a retaining/locking ring on the outer ring or on the inner ring, generates frictional losses, as only the outer ring performs a rotary movement around the journal axis when the inner joint part is displaced along the first axis of rotation.

The concave design of the inner circumferential surface now serves to fix the inner ring on the respective journal, while the outer circumferential surface is guided in the raceways or fixed by the raceways (e.g. relative to the circumferential direction around the first axis of rotation and relative to the radial direction).

In particular, each contact surface may extend over an angular range extending around the respective journal axis, which is less than 180 angular degrees, which may be less than 150 angular degrees, or less than 130 angular degrees.

In particular, the inner joint part may have a central cross-sectional plane which extends transversely to the second axis of rotation and intersects the center of mass of the inner joint part. In this cross-sectional plane, the joint inner part has a minimum thickness (the sum of a first thickness and a second thickness) along the radial direction or along the respective journal axis between the central body and the contact surfaces. A first thickness, which extends from the journal axis to the first surface of the joint inner part, which is arranged adjacent to the first contact surface, is smaller or greater than a second thickness, which extends from the journal axis to the second surface of the joint inner part, which is arranged adjacent to the second contact surface. The difference between the first thickness and the second thickness is at least one percent, which may be at least five percent, of the greater thickness.

A joint inner part for a tripod joint is further proposed, which may be for the tripod joint described above. In particular, the inner joint part may have at least one central body extending along a second axis of rotation and three journals extending from the central body along a radial direction, each having a journal axis and arranged distributed in the circumferential direction. Each journal has contact surfaces for contacting a roller body of the tripod joint. A first contact surface is oriented at least towards a first circumferential direction and a second contact surface is oriented at least towards a second circumferential direction opposite to the first circumferential direction. The first contact surfaces have a first pitch circle radius and the second contact surfaces have a second pitch circle radius, wherein the first pitch circle radius and the second pitch circle radius have different values from one another.

The inner joint part or at least the contact surfaces can be produced by a machining (e.g. turning, milling, grinding) or forming (e.g. forging) process.

The remarks on the tripod joint are particularly applicable to the inner joint part and vice versa.

The described tripod joint or a tripod joint with the described joint inner part may be used on a side shaft of a motor vehicle. In particular, the side shaft may be connected to a drive unit of the motor vehicle, so that a torque of the drive unit can be transmitted to a wheel of the motor vehicle via the tripod joint.

The use of indefinite articles (“a”, “an”), in particular in the claims and the description reproducing them, is to be understood as such and not as a number word. Accordingly, terms or components introduced thereby are to be understood as being present at least once and, in particular, may also be present more than once.

As a precaution, it should be noted that the number words used here (“first”, “second”, . . . ) are primarily (only) used to distinguish between several similar objects, quantities or processes, i.e. in particular they do not necessarily specify any dependency and/or sequence of these objects, quantities or processes in relation to one another. If a dependency and/or sequence is required, this is explicitly stated here or is obvious to the person skilled in the art when studying the specific embodiment described. Insofar as a component may occur more than once (“at least one”), the description of one of these components may apply equally to all or some of the plurality of these components, but this is not mandatory.

### BRIEF DESCRIPTION OF THE DRAWINGS

The disclosure and the technical context are explained in more detail below with reference to the accompanying figures. It should be noted that the disclosure is not intended to be limited by the embodiments given. In particular, it should be noted that the figures and in particular the proportions shown are only schematic. The figures show

FIG. 1 a side shaft of a motor vehicle in pull mode;

FIG. 2 the side shaft according to FIG. 1 in push or sail mode;

FIG. 3 a known tripod joint in a view along the coaxially arranged axes of rotation;

FIG. 4 a tripod joint according to DE 41 30 183 A1;

FIG. 5 a first diagram;

FIG. 6 a second diagram;

FIG. 7 the tripod joint according to FIG. 3 with driven outer joint part;

FIG. 8 a tripod joint in a view along the coaxially arranged axes of rotation, with driven outer joint part;

FIG. 9 the tripod joint according to FIGS. 3 and 7 with driven joint inner part;

FIG. 10 the tripod joint according to FIG. 8 with driven joint inner part;

FIG. 11 the joint outer part of the tripod joints according to FIGS. 3, 4 and 7 to 10;

FIG. 12 a first design variant of the joint inner part, in a view along the second axis of rotation;

FIG. 13 a second design variant of the inner joint part, in a view along the second axis of rotation;

FIG. 14 a third diagram;

FIG. 15 a fourth diagram;

FIG. 16 a part of an inner joint part, in a third design variant, in a view along the second axis of rotation;

FIG. 17 a part of an inner joint part, in a fourth design variant, in a view along the second axis of rotation;

FIG. 18 an inner joint part in a view along the second axis of rotation;

FIG. 19 the inner joint part according to FIG. 18 in a view along a journal axis;

FIG. 20 the inner joint part according to FIGS. 18 and 19 in a side view;

FIG. 21 a tripod joint in a view along the axes of rotation, with the inner joint part according to FIGS. 18 to 20, partially in section;

FIG. 22 the inner joint part with roller body according to FIG. 21, in a view along a journal axis;

FIG. 23 the inner joint part with roller body according to FIG. 22, in a view along the second axis of rotation, partially in section;

FIG. 24 the tripod joint according to FIG. 21, in a side view, in section;

FIG. 25 a third design variant of the inner joint part, in a view along the second axis of rotation;

FIG. 26 a detail of the inner joint part according to FIG. 26, in a view along the second axis of rotation; and

FIG. 27 a detail of a fourth design variant of the inner joint part, in a view along the second axis of rotation.

### DETAILED DESCRIPTION

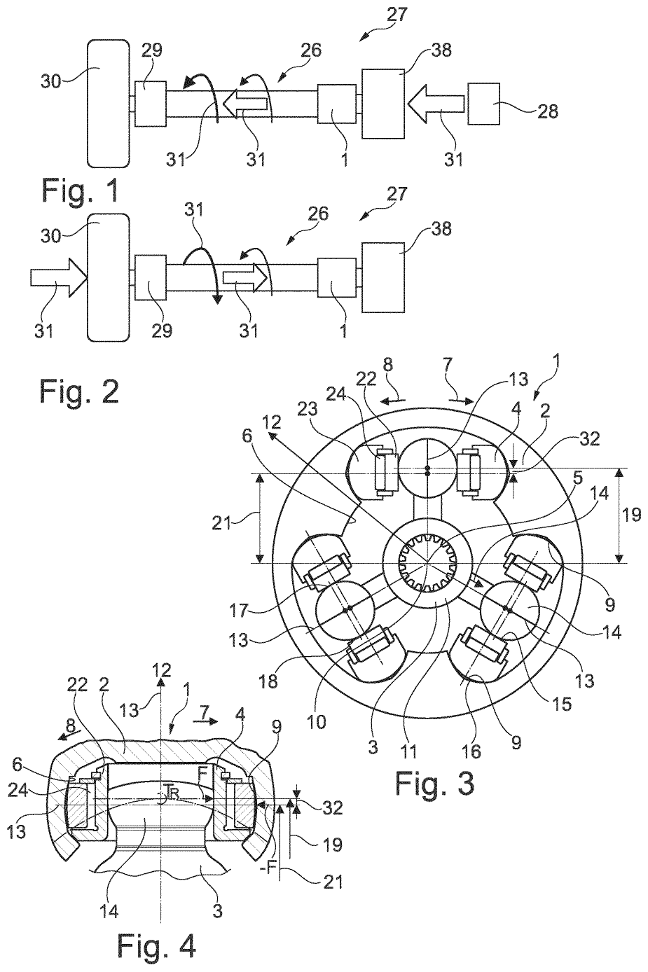

FIG. 1 shows a side shaft 26 of a motor vehicle 27 in traction/pull mode. The side shaft 26 connects a wheel 30 of the motor vehicle 27 to a drive unit 28 or a gearbox 38. The side shaft 26 comprises a tripod joint 1 on the side of the drive unit 28 or gearbox 38 and a further joint 29 on the side of the wheel 30. In traction mode, the direction of the torques 31 introduced and the direction of rotation of the side shaft 26 are in the same direction (see arrows).

FIG. 2 shows the side shaft 26 according to FIG. 1 in push or sail mode. Please refer to the comments on FIG. 1. In the push or sail mode, the direction of the torques 31 introduced and the direction of rotation of the side shaft 26 are opposite to each other.

FIG. 3 shows a known tripod joint 1 in a view along the coaxially arranged axes of rotation 5, 10. FIG. 4 shows a tripod joint 1 according to DE 41 30 183 A1. FIGS. 3 and 4 are described together below. Reference is made to the comments on FIGS. 1 and 2.

The tripod joint 1 comprises an outer joint part 2 and an inner joint part 3 as well as a plurality of roller bodies 4. The tripod joint 1 is a sliding joint in which the inner joint part 3 is displaceable along the first axis of rotation 5 relative to the outer joint part 2. The outer joint part 2 has a receptacle 6 for the inner joint part 3 extending along a first axis of rotation 5 and three raceways 9 extending along the first axis of rotation 5 and evenly distributed in a circumferential direction 7, 8. The inner joint part 3 has a central body 11 extending along a second axis of rotation 10 and three journals 14 extending from the central body 11 along a radial direction 12, each having a journal axis 13 and arranged evenly distributed in the circumferential direction 7, 8.

A roller body 4 is arranged on each journal 14, which contacts the journal 14 with an inner circumferential surface 15 and the respective raceway 9 with an outer circumferential surface 16. Each journal 14 has contact surfaces 17, 18 for contacting the inner circumferential surface 15, wherein a first contact surface 17 is oriented at least towards a first circumferential direction 7 and a second contact surface 18 is oriented at least towards a second circumferential direction 8, which is directed in the opposite direction to the first circumferential direction 7. If the axes of rotation 5, 10 are arranged coaxially to one another, the first and second contact surfaces 17, 18 have a first pitch radius 19 and the raceways 9 have a third pitch radius 21.

To achieve particularly advantageous guiding properties, an offset 32 is provided between the first pitch radii 19 of the contact surfaces 17, 18 of the journals 14 and the third pitch radii 21 of the raceways 9.

Each roller body 4 comprises an inner ring 22 having an inner circumferential surface 15, an outer ring 23 having an outer circumferential surface 16 and a plurality of rolling elements 24 between the inner ring 22 and the outer ring 23.

During traction mode of a motor vehicle 27, i.e. when the motor vehicle 27 is driven by a drive unit 28, the journal 14 contacts the roller body 4 with one of the contact surfaces 17, 18 and the roller body 4 contacts only one side of the raceways 9. In push mode or in sail mode (coasting) of the motor vehicle 27, i.e. when drive torques are introduced starting from the wheel 30 and the drive unit 28 is still connected (push mode) or decoupled (sail mode), the journal 14 contacts the roller body 4 with the other of the contact surfaces 18, 17 and the roller body 4 contacts only the other side of the raceways 9.

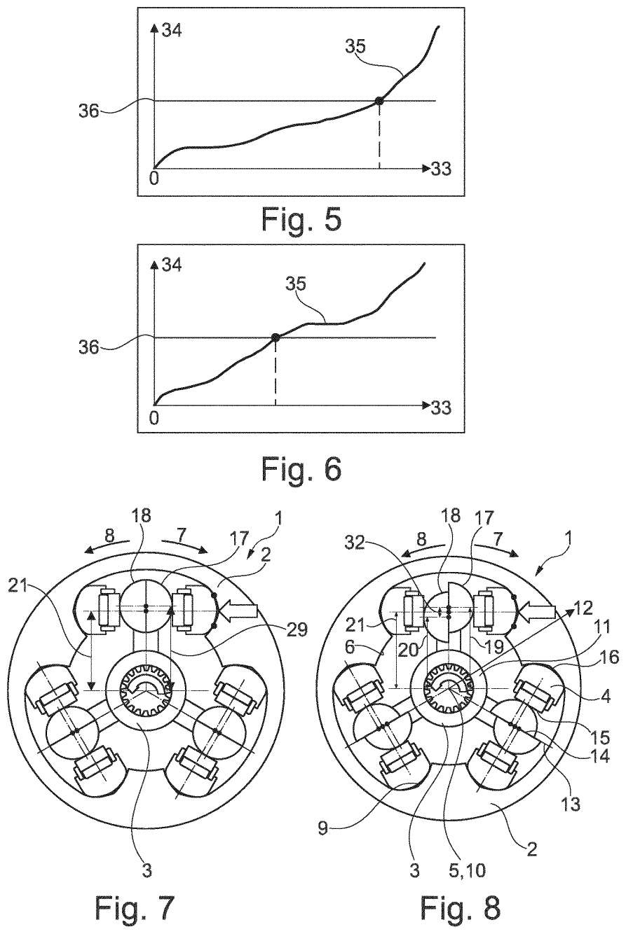

FIG. 5 shows a first diagram. FIG. 6 shows a second diagram. FIGS. 5 and 6 are described together. The ACFG value 34 is plotted in [Nrms] on the respective vertical axis and the deflection angle 33 of the tripod joint 1 is plotted in [angular degrees] on the horizontal axis.

The ACFG value 34 varies as a function of the deflection angle 33 of the tripod joint 1, whereby the course 35 of the value as a function of the deflection angle 33 is defined and can be determined for each tripod joint 1. The range of use of the tripod joint 1 is thus limited by a maximum deflection angle 33 at which the ACFG value 34 exceeds a maximum value 36 that is still considered permissible.

FIG. 5 shows the course 35 for the traction mode of the tripod joint 1 according to FIGS. 3 and 4. FIG. 6 shows the course 35 for the push/sail mode of this tripod joint 1. It can be seen that the range of use of the tripod joint 1 is limited by the deflection angle 33, which is exceeded in push/sail mode at a maximum value 36 of the ACFG value 34 that is still considered permissible.

FIG. 7 shows the tripod joint 1 according to FIG. 3 with driven outer joint part 2. The arrow shows the resulting torque 31 acting on the effective radius of the outer joint part 2.

FIG. 8 shows a tripod joint 1 in a view along the coaxially arranged axes of rotation 5, 10, with driven outer joint part 2. The tripod joint 1 comprises an outer joint part 2 and an inner joint part 3 as well as a plurality of roller bodies 4. The tripod joint 1 is a sliding joint in which the inner joint part 3 can be displaced along the first axis of rotation 5 relative to the outer joint part 2. The outer joint part 2 has a receptacle 6 for the inner joint part 3 extending along a first axis of rotation 5 and three raceways 9 extending along the first axis of rotation 5 and evenly distributed in a circumferential direction 7, 8. The inner joint part 3 has a central body 11 extending along a second axis of rotation 10 and three journals 14 extending from the central body 11 along a radial direction 12, each having a journal axis 13 and arranged evenly distributed in the circumferential direction 7, 8.

A roller body 4 is arranged on each journal 14, which contacts the journal 14 with an inner circumferential surface 15 and the respective raceway 9 with an outer circumferential surface 16. Each journal 14 has contact surfaces 17, 18 for contacting the inner circumferential surface 15, wherein a first contact surface 17 is oriented at least towards a first circumferential direction 7 and a second contact surface 18 is oriented at least towards a second circumferential direction 8, which is directed in the opposite direction to the first circumferential direction 7.

Each roller body 4 comprises an inner ring 22 having an inner circumferential surface 15, an outer ring 23 having an outer circumferential surface 16 and a plurality of rolling elements 24 between the inner ring 22 and the outer ring 23.

When the axes of rotation 5, 10 are arranged coaxially to one another, the first contact surfaces 17 have a first pitch circle radius 19, the second contact surfaces 18 have a second pitch circle radius 20 and the raceways 9 have a third pitch circle radius 21, with at least the first pitch circle radius 19 and the second pitch circle radius 20 having different values from one another.

The outer circumferential surface 16 of the roller body 4 can be rotated relative to the inner circumferential surface 15 of the roller body 4. The inner circumferential surface 15 is formed by an inner ring 22, which contacts the journal 14 or the contact surfaces 17, 18. Rolling elements 24 are arranged between the inner ring 22 and the outer circumferential surface 16, so that relative rotation is possible.

The rotation of the inner circumferential surface 15 relative to the outer circumferential surface 16 allows the roller body 4 to roll along the raceways 9, so that the inner joint part 3 can be displaced along the first axis of rotation 5 relative to the outer joint part 2.

When the inner joint part 3 is deflected, the roller bodies 4 are guided further through the raceways 9, whereby the journals 14 are tilted relative to the roller bodies 4.

The inner circumferential surface 15 and the outer circumferential surface 16 do not perform any further relative movement to each other apart from the relative rotation.

The pitch circle radius 19, 20 of the journals 14 is the so-called effective radius. This is defined for an extended tripod joint 1, i.e. the axes of rotation 5, 10 are arranged coaxially to each other. The effective radius defines the lever arm of the force resultant when transmitting a torque 31 (see arrow in FIG. 8). The pitch circle radius 19, 20 of the journals 14 is therefore the radius, starting from the second axis of rotation 10, on which the centers of the spherical segment-shaped contact surfaces 17, 18 of the journal 14 are arranged when the tripod joint 1 is extended.

The proposed tripod joint 1 with the different pitch circle radii 19, 20 on the contact surfaces 17, 18 now enables adaptation to push or sail mode on the one hand and adaptation to pull mode on the other. The contact surfaces 17, 18, which are oriented in different circumferential directions 7, 8, therefore have different properties, i.e. different pitch circle radii 19, 20. Accordingly, by adapting the first pitch radius 19, an ACFG value 34 of the tripod joint 1 can be designed specifically for push mode or sail mode and by adapting the second pitch radius 20, an ACFG value 34 can be designed specifically for pull mode.

Here, the second pitch circle radius 20 is smaller than the third pitch circle radius 21 and the first pitch circle radius 19 is larger than the third pitch circle radius 21.

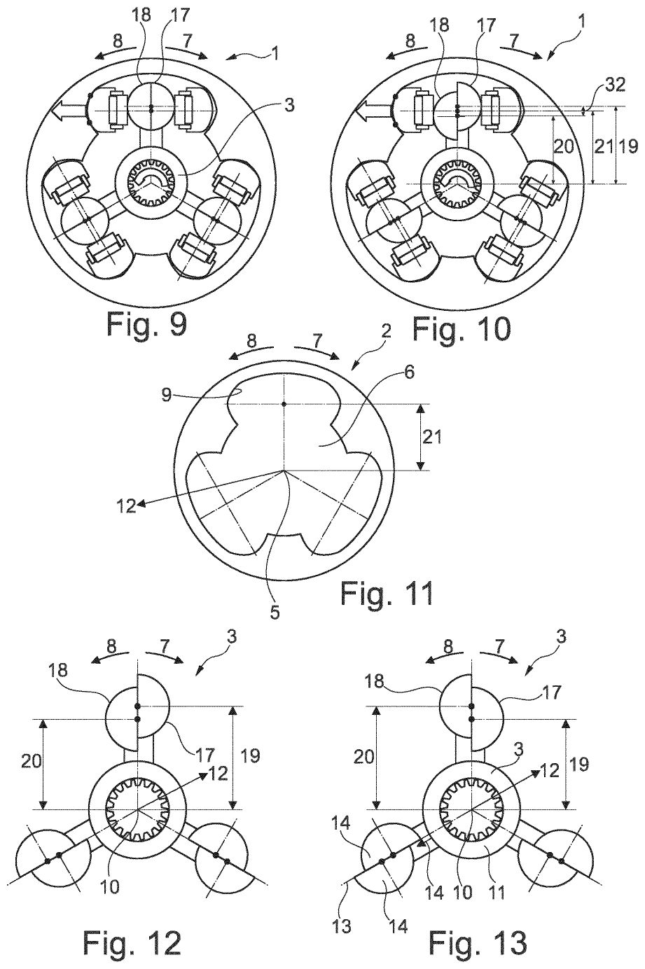

FIG. 9 shows the tripod joint 1 according to FIGS. 3 and 7 with driven joint inner part 3. Reference is made to FIG. 7. The arrow shows the resulting torque 31 acting on the effective radius of the outer joint part 2, the third pitch radius 21.

FIG. 10 shows the tripod joint 1 according to FIG. 8 with driven inner joint part 3. Reference is made to FIG. 8. The arrow shows the resulting torque 31 acting on the effective radius of the outer joint part 2, the third pitch circle radius 21.

FIG. 11 shows the outer joint part 2 of the tripod joints 1 according to FIGS. 3, 4 and 7 to 10. The outer joint part 2 has a receptacle 6 for the inner joint part 3 extending along a first axis of rotation 5 and three raceways 9 extending along the first axis of rotation 5 and evenly distributed in a circumferential direction 7, 8.

The raceways 9 are curved in the cross-section shown, which extends transversely to the first axis of rotation 5. The course of the raceway 9 in this cross-section is formed by several radii. The curvature is concave in relation to the outer circumferential surface 16 of the roller body 4. The course of the curvature is in the form of a pointed arch, also known as a Gothic arch. The outer circumferential surface 16 makes contact with the surface of the raceways 9 in the cross-section at two points (see also FIGS. 7 to 10).

The outer joint part 2 has raceways 9 that are arranged on the third pitch circle radius 21.

FIG. 12 shows a first design variant of the inner joint part 3, in a view along the second axis of rotation 10. Reference is made to the comments on FIG. 10 and the inner joint part 3 shown there.

Each journal 14 has contact surfaces 17, 18 for contacting the inner circumferential surface 15, wherein a first contact surface 17 is oriented at least towards a first circumferential direction 7 and a second contact surface 18 is oriented at least towards a second circumferential direction 8 that is opposite to the first circumferential direction 7. The first contact surfaces 17 have a first pitch circle radius 19 and the second contact surfaces 18 have a second pitch circle radius 20, wherein the first pitch circle radius 19 is larger than the second pitch circle radius 20.

FIG. 13 shows a second design variant of the joint inner part 3, in a view along the second axis of rotation 10. Reference is made to the comments on FIG. 12.

In contrast to the first embodiment variant, the first pitch circle radius 19 is smaller here than the second pitch circle radius 20.

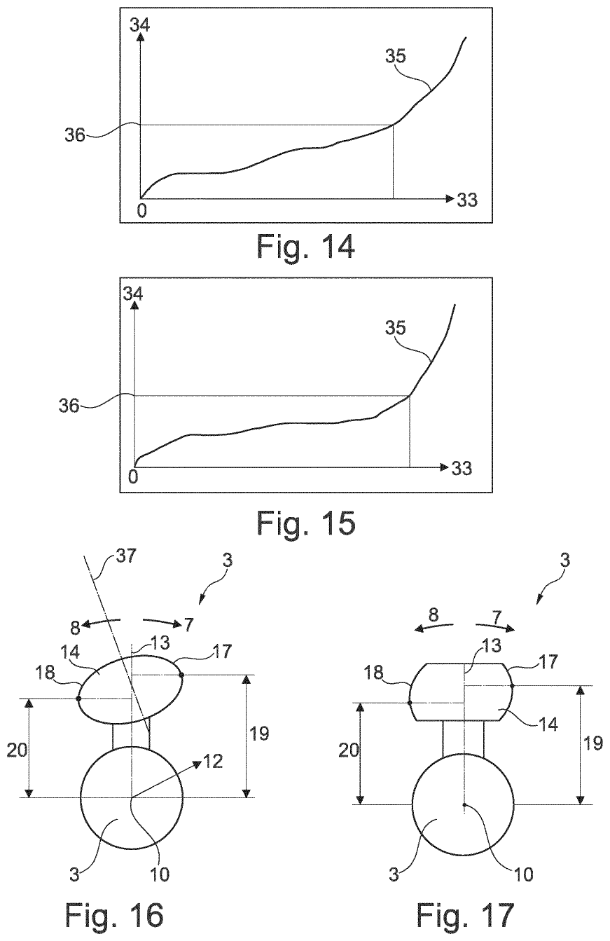

FIG. 14 shows a third diagram. FIG. 15 shows a fourth diagram. Reference is made to the comments on FIGS. 5 and 6. FIGS. 14 and 15 are described together.

The ACFG value 34 is plotted in [Nrms] on the respective vertical axis and the deflection angle 33 of the tripod joint 1 is plotted in [angular degrees] on the horizontal axis.

The ACFG value 34 varies as a function of the deflection angle 33 of the tripod joint 1, whereby the course 35 of the value as a function of the deflection angle 33 is defined and can be determined for each tripod joint 1. The range of use of the tripod joint 1 is thus limited by a maximum deflection angle 33 at which the ACFG value 34 exceeds a maximum value 36 that is still considered permissible.

FIG. 14 shows the course 35 for the traction mode of the tripod joint 1 according to FIGS. 8 and 10 to 13. FIG. 15 shows the course 35 for the push/sail mode of this tripod joint 1. It can be seen that the range of use of the tripod joint 1 is only limited by a fairly large value of a deflection angle 33, which is exceeded in both operating modes at a maximum value 36 of the ACFG value 34 that is still considered permissible.

FIG. 16 shows a part of an inner joint part 3, in a third design variant, in a view along the second axis of rotation 10. Here, the journal 14 is produced by a machining manufacturing process. The axis of rotation 37 of the journal geometry used for the manufacturing process can be seen.

FIG. 17 shows a part of an inner joint part 3, in a fourth design variant, in a view along the second axis of rotation 10. Here, the journal 14 is produced by a forging process.

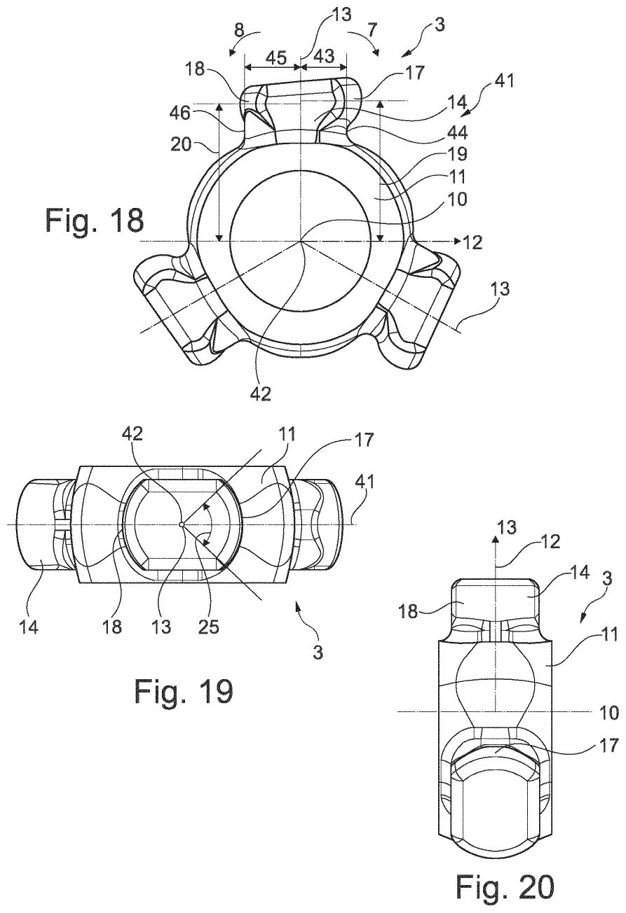

FIG. 18 shows an inner joint part 3 in a view along the second axis of rotation 10. FIG. 19 shows the inner joint part 3 according to FIG. 18 in a view along a journal axis 13. FIG. 20 shows the inner joint part 3 according to FIGS. 18 and 19 in a side view. FIGS. 18 to 20 are described together below. Reference is made to the explanations of FIGS. 8 and 10 to 17.

Each journal 14 has contact surfaces 17, 18 for contacting the inner circumferential surface 15, wherein a first contact surface 17 is oriented at least towards a first circumferential direction 7 and a second contact surface 18 is oriented at least towards a second circumferential direction 8 directed in the opposite direction to the first circumferential direction 7.

Each contact surface 17, 18 extends over an angular range 25 extending around the respective journal axis 13, which has less than 150 angular degrees.

The joint inner part 3 has a central cross-sectional plane 41 which extends transversely to the second axis of rotation 10 and intersects the center of mass 42 of the joint inner part 3. In this central cross-sectional plane 41, the inner joint part 3 has a minimum thickness (the sum of a first thickness 43 and a second thickness 45) along the radial direction 12 or along the respective journal axis 13 between the central body 11 and the contact surfaces 17, 18. A first thickness 43, which extends from the journal axis 13 to the first surface 44 of the inner joint part 3, which is arranged adjacent to the first contact surface 17, is smaller than a second thickness 45, which extends from the journal axis 13 to the second surface 46 of the inner joint part 3, which is arranged adjacent to the second contact surface 18.

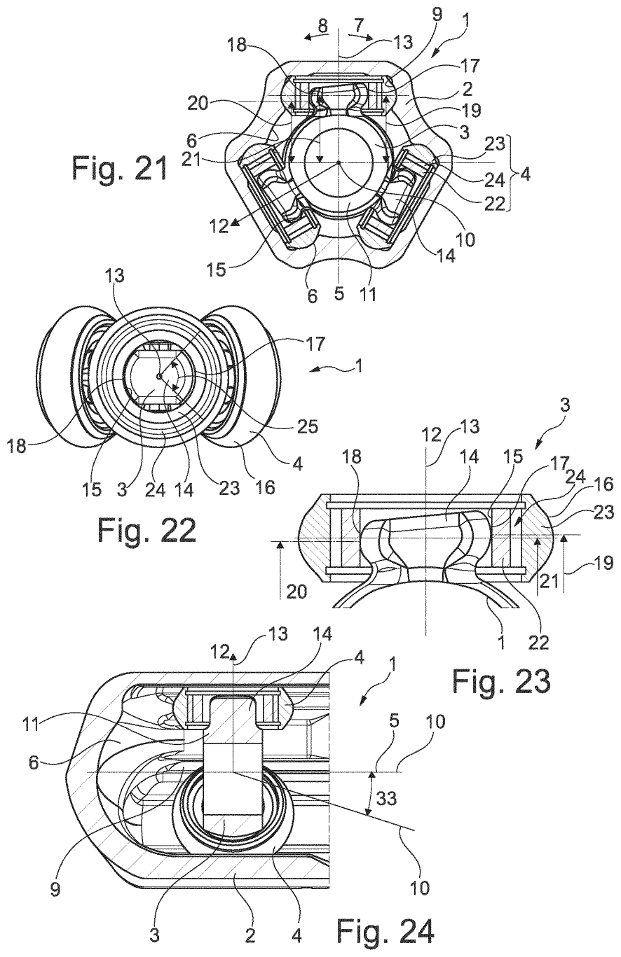

FIG. 21 shows a tripod joint 1 in a view along the axes of rotation 5, 10, with the inner joint part 3 according to FIGS. 18 to 20, partly in section. FIG. 22 shows the inner joint part 3 with roller body 4 according to FIG. 21, in a view along a journal axis 13. FIG. 23 shows the inner joint part 3 with roller body 4 according to FIG. 22, in a view along the second axis of rotation 10, partly in section. FIG. 24 shows the tripod joint 1 according to FIG. 21, in a side view, in section. FIGS. 21 to 24 are described together below. Reference is made to the comments on FIGS. 8 and 10 to 20.

The tripod joint 1 comprises an outer joint part 2 and an inner joint part 3 as well as a plurality of roller bodies 4. The tripod joint 1 is a sliding joint in which the inner joint part 3 can be displaced along the first axis of rotation 5 relative to the outer joint part 2. The outer joint part 2 has a receptacle 6 for the inner joint part 3 extending along a first axis of rotation 5 and three raceways 9 extending along the first axis of rotation 5 and evenly distributed in a circumferential direction 7, 8. The inner joint part 3 has a central body 11 extending along a second axis of rotation 10 and three journals 14 extending from the central body 11 along a radial direction 12, each having a journal axis 13 and arranged evenly distributed in the circumferential direction 7, 8.

A roller body 4 is arranged on each journal 14, which contacts the journal 14 with an inner circumferential surface 15 and the respective raceway 9 with an outer circumferential surface 16. Each journal 14 has the contact surfaces 17, 18 described with respect to FIGS. 18 to 20 for contacting the inner circumferential surface 15, a first contact surface 17 being oriented at least towards a first circumferential direction 7 and a second contact surface 18 being oriented at least towards a second circumferential direction 8 directed in the opposite direction to the first circumferential direction 7.

The outer circumferential surface 16 of the roller body 4 can be rotated relative to the inner circumferential surface 15 of the roller body 4. The inner circumferential surface 15 is formed by an inner ring 22, which contacts the journal 14 or the contact surfaces 17, 18. Rolling elements 24 are arranged between the inner ring 22 and the outer circumferential surface 16, so that relative rotation is possible.

The rotation of the inner circumferential surface 15 relative to the outer circumferential surface 16 allows the roller body 4 to roll along the raceways 9, so that the inner joint part 3 can be displaced along the first axis of rotation 5 relative to the outer joint part 2.

When the inner joint part 3 is deflected, the roller bodies 4 are guided further through the raceways 9, whereby the journals 14 are pivoted relative to the roller bodies 4. A deflection angle 33, which is set between the first axis of rotation 5 and the second axis of rotation 10, is indicated in FIG. 24.

The inner circumferential surface 15 and the outer circumferential surface 16 do not perform any further relative movement to each other apart from the relative rotation.

The proposed tripod joint 1 with the different pitch circle radii 19, 20 on the contact surfaces 17, 18 now enables adaptation to push or sail mode on the one hand and adaptation to pull mode on the other.

Here, the second pitch circle radius 20 is smaller than the third pitch circle radius 21 and the first pitch circle radius 19 is larger than the third pitch circle radius 21.

Each roller body 4 comprises an inner ring 22 with an inner circumferential surface 15, an outer ring 23 with an outer circumferential surface 16 and a plurality of rolling elements 24 between the inner ring 22 and the outer ring 23. The outer circumferential surface 16 has a convex shape relative to the raceways 9. The inner circumferential surface 15 is cylindrical.

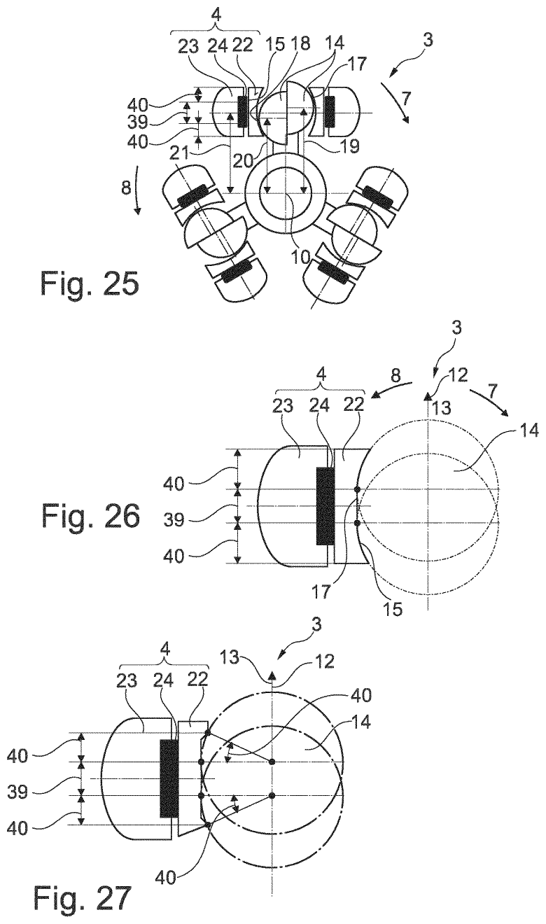

FIG. 25 shows a third design variant of the inner joint part 3, in a view along the second axis of rotation 10. FIG. 26 shows a detail of the inner joint part 3 according to FIG. 26, in a view along the second axis of rotation 10. FIG. 27 shows a detail of a fourth design variant of the inner joint part 3, in a view along the second axis of rotation 10.

In contrast to the first and second design variants, here the inner circumferential surface 15 is concave in relation to the contact surfaces 17, 18. In this context, concave means that the inner circumferential surface 15 has a central region 39 set back relative to the contact surfaces 17, 18 and, adjacent to the central region 39, an outer region 40 projecting towards the contact surfaces 17, 18 in each case.

In the third and fourth design variants, the central region 39 is cylindrical. In the third design variant variant, the outer regions 40 have a curved shape (see FIG. 26). In the fourth design variant, the outer areas 40 have an at least partially conical shape starting from the cylindrical central area 39.

The concave design of the inner circumferential surface 15 enables the roller body 4 or the inner ring 22 to be fixed on the journal 14 during operation of the tripod joint 1. This means that the inner ring 22 does not need to be fixed relative to the outer ring 23.

Usually, for example, such a fixation is provided so that the inner ring 22 can only rotate relative to the outer ring 23. However, this fixation, usually a retaining/locking ring on the outer ring 23 or on the inner ring 22, generates frictional losses, since only the outer ring 23 performs a rotary movement about the journal axis 13 when the inner joint part 3 is displaced along the first axis of rotation 5.

The concave design of the inner circumferential surface 15 now serves to fix the inner ring 22 on the respective journal 14, while the outer circumferential surface 16 is guided in the raceways 9 or is fixed by the raceways 9 (e.g. relative to the circumferential direction 7, 8 around the first axis of rotation 5 and relative to the radial direction 12).

1. A tripod joint comprising at least an outer joint part and an inner joint part as well as a plurality of roller bodies wherein the outer joint part has a receptacle for the inner joint part extending along a first axis of rotation and three raceways extending along the first axis of rotation and distributed in a circumferential direction wherein the joint inner part has a central body extending along a second axis of rotation and three journals extending from the central body along a radial direction, each having a journal axis and being distributed in the circumferential direction, wherein one of the roller bodies is arranged on each journal which contacts the journal with an inner circumferential surface and the respective raceway with an outer circumferential surface wherein each journal has contact surfaces for contacting the inner circumferential surface a first contact surface being oriented at least towards a first circumferential direction and a second contact surface being oriented at least towards a second circumferential direction directed in the opposite direction to the first circumferential direction wherein, when the axes of rotation are arranged coaxially to one another, the first contact surfaces have a first pitch circle radius the second contact surfaces have a second pitch circle radius and the raceways have a third pitch circle radius, wherein at least the first pitch circle radius and the second pitch circle radius have different values from one another.

2. The tripod joint according to claim 1, wherein the first pitch circle radius is smaller or larger than the third pitch circle radius.

3. Tripod joint according to claim 1, wherein the second pitch circle radius is larger or smaller than the third pitch circle radius.

4. Tripod joint according to claim 1, wherein the value of the first pitch circle radius or of the second pitch circle radius corresponds to the value of the third pitch circle radius.

5. The tripod joint according to claim 1, wherein the third pitch circle radius is larger or smaller than the first pitch circle radius and the second pitch circle radius.

6. The tripod joint according to claim 1, wherein each roller body comprises an inner ring having the inner circumferential surface an outer ring having the outer circumferential surface and a plurality of rolling elements between the inner ring and the outer ring

7. The tripod joint according to claim 1, wherein the outer circumferential surface has a convex shape relative to the raceways.

8. The tripod joint according to claim 1, wherein the inner circumferential surface is cylindrical.

9. The tripod joint according to claim 1, wherein the inner circumferential surface is concave with respect to the contact surfaces.

10. The tripod joint according to claim 1, wherein each contact surface extends over an angular range which extends around the respective journal axis and has less than 180 angular degrees.

11. An inner joint part for a tripod joint comprising at least a central body extending along a second axis of rotation and three journals extending from the central body along a radial direction each having a journal axis and arranged distributed in the circumferential direction, each journal having contact surfaces for contacting a roller body of the tripod joint which can be arranged on each journal a first contact surface being oriented at least towards a first circumferential direction and a second contact surface being oriented at least towards a second circumferential direction directed in the opposite direction to the first circumferential direction wherein the first contact surfaces have a first pitch circle radius and the second contact surfaces have a second pitch circle radius, wherein the first pitch circle radius and the second pitch circle radius have different values from each other.
